(19) United States
(12) Patent Application Publication
(10) Pub. No.: US 2008/0288271 A1
(43) Pub. Date: Nov. 20, 2008

(54) Internet-Based Survey System and Method

(76) Inventor: Claudia Jean Faust, Plantation, FL (US)

Correspondence Address: Ms. Claudia J. Faust, 1836 NW 97 Avenue, Plantation, FL, 33322, US

(21) Appl. No.: 11/854,550

(22) Filed: Sep. 13, 2007

Related U.S. Application Data
(60) Provisional application No. 60/854,125, filed on Oct. 25, 2006.

(51) Int. Cl. G06Q 99/00

(52) U.S. Cl. 705/1

(57) ABSTRACT

An Internet-based survey system, method and computer-readable medium that captures feedback from job seekers and employees at various stages of pre- and post-hire, and aggregates their perceptions of various aspects of the company in order to formulate and display resulting data which helps a company create more targeted and cost-effective hiring and retention strategies. The system creates survey questions; stores and presents those questions in a library which can be customized to the requirements of a specific client; provides an automation component which captures requisite identification information about potential survey taker and imports it into the survey system; extends survey invitations to solicit participation from potential survey takers; captures demographic data from each participating survey taker; dynamically presents at least one survey question to survey takers in real-time; receives, calculates, aggregates and benchmarks statistics for demographics, response option values and survey participation; and presents reports adapted to at least one client.

### FIELD OF THE INVENTION

The present invention relates generally to survey presentation and processing systems. More particularly, the present invention relates to a real-time, online feedback portal that helps companies understand the experiences and perceptions of individuals at all stages of the employment life cycle i.e., from the job application stage to the separation stage. It is very user friendly and results-oriented. As a diagnostic tool, the system gathers and measures feedback to help companies learn how they are perceived as employers and what changes they can make to enhance that image in order to attract, find, keep, and predict better hires.

### BACKGROUND OF THE INVENTION

Employee job performance and retention is a major concern for companies of every size. For a company with 1,000 employees it is estimated that the costs of poor employee job performance can range from $10 million to $25 million per year. According to some estimates, the costs of employee vacancy can range from $7,000 to $12,000 or more per day, depending on the industry. Therefore, it is financially prudent for companies to recruit, hire and retain talented and productive employees. Unfortunately, most companies make hiring decisions armed with a less than sufficient cache of information.

In order to improve recruiting and retention of valuable employees, Human Resources (HR) and recruiting departments work to establish and clearly define targeted, cost-effective hiring and retention strategies. To do this more efficiently, employers need constant and better business “recruiting intelligence.” One component of developing improved recruiting intelligence is gaining a better understanding of how the hiring company is perceived in the talent marketplace (e.g., as a good employer? cut-throat culture? long hours? family friendly atmosphere? good compensation?). A second important component of developing improved recruiting intelligence is determining key job attributes that attract qualified applicants to a company's talent pool. A third important component is gaining an understanding of the effect that diversity and other outreach programs are having on targeted talent. Finally, a fourth important component is identifying specific reasons why a company loses good employees (e.g., limited advancement opportunities? work environment issues? compensation issues?).

Presently, there are only disjointed means available to employers to efficiently gather, report and benchmark such information in a timely and cost-effective manner. Accordingly, it would be highly desirable to provide a centralized, online, portal-based system and method for capturing, reporting and benchmarking feedback at all stages of the employment lifecycle to improve and better manage the aforementioned components. As a result, improved business intelligence for HR departments and recruiting professionals could enable companies to more strategically manage talent acquisition and retention. It would be desirable to provide such a system and method that also helps companies understand and calibrate the relationship between improvements to early workforce engagement with improvements to business performance metrics.

### SUMMARY OF THE INVENTION

The present invention is generally directed to an online, portal-based survey system and method which polls individuals as potential employees, recently-hired employees, long-term employees, retirees and/or others separating from the company's employment. The surveys are continuously administered at various trigger points in the hiring, employment and separation processes, collecting perceptions of various aspects of the company which are then aggregated and presented in a manner that allows the reader to formulate targeted and cost-effective hiring and retention strategies. The system includes a software program that solicits information regarding the demographics, perceptions and experiences of individuals at key points in the employment lifecycle, using online surveys accessed by survey takers over a secure server. Using data obtained through the aggregate survey results, a company can continually adjust or modify its recruitment, employment and/or retirement policies and programs accordingly, to improve and facilitate the recruitment, employment and retention of talented and productive employees. In other words, as a diagnostic tool, the system gathers and measures this feedback so that companies can learn how they are perceived as employers and what changes can be made to enhance that image. Significantly, in addition to this “perception capture” capability, the invention may also include an integral “metrics capture” capability to help companies to calibrate the relationship between improvements to early workforce experience and improvements to business performance metrics. Accordingly, clients of the system can access and utilize one or more system components in order to attract better hires, make better hires, keep better hires, and predict better hires.

In one general aspect of the present invention, the Internet-based survey system and method typically comprises:

a “Survey Element” component adapted to create at least one survey question (FIG. 2);

a “Survey Development” component adapted to present and customize a standard library of survey elements to at least one client (FIG. 3);

a “Survey Automation” component adapted to capture required information about at least one survey taker from at least one client (FIG. 4);

a “Survey Invitation” component adapted to solicit survey participation from at least one potential survey taker (FIG. 5);

a “Demographic Data Capture” component adapted to solicit demographic background information from at least one survey taker (FIG. 6);

a “Survey Presentation” component adapted to present survey elements in real-time and receive at least one survey response from at least one survey taker (FIG. 7); and

a “Report Calculation” Component adapted to tabulate survey participation, aggregate response option values and benchmarking based on at least one captured survey response (FIG. 8).

a “Report Viewing and Presentation” Component adapted to formulate a report based on at least one captured survey response (FIG. 9).

In another aspect of the invention, the survey elements may include category, type, text, threshold value, relative importance value, trigger condition, level, response options, and response option values.

In another aspect of the invention, the survey elements may be saved in a question format.

In another aspect of the invention, the questions may be stored in a question library.

In another aspect of the invention, the system and method help companies understand the experiences and perceptions of individuals in the employment life cycle (e.g., from the job application stage to the employment separation stage).

In another aspect of the invention, the system and method function as a diagnostic tool: gathering, measuring and benchmarking real-time, ongoing feedback to help companies learn how they are perceived as employers and what changes can be made to enhance that image in order to attract, make, keep, and predict better hires.

In another aspect of the invention, the system and method help companies to calibrate the relationship between improvements to early workforce experience and engagement with improvements to business performance metrics.

These and other aspects, features, and advantages of the present invention will become more readily apparent from the attached drawings and the detailed description of the preferred embodiments, which follow.

### BRIEF DESCRIPTION OF THE DRAWINGS

FIG. 1 is a system architecture diagram illustrating the system overview, data flow and operating environment for an actual embodiment of the present invention.

FIG. 2 is a diagram and an illustration of data captured and connected in the system to every question in the library and contents of the survey database utilized in the embodiment of the present invention.

FIG. 3 is a flow diagram showing an illustrative routine of developing an electronic survey. This component is adapted to present and customize a standard library of survey questions.

FIG. 4 is a flow diagram showing an illustrative routine of data transfer. This component is adapted to transfer required identification information about at least one survey taker from the client's system into the survey system.

FIG. 5 is a flow diagram showing an illustrative routine of issuing a survey invitation; this component is adapted to solicit survey participation from at least one survey taker.

FIG. 6 is a flow diagram of demographic data capture. This component is adapted to show an illustrative routine for soliciting demographic background information from at least one survey taker.

FIG. 7 is a flow diagram of the survey presentation component. It is adapted to show an illustrative routine to present survey elements in real time and receive survey responses from survey taker.

FIG. 8 is a flow diagram of the report calculation component. It is adapted to show an illustrative routine to calculate survey participation, aggregate scoring and benchmark data based on at least one survey response.

FIG. 9 is a flow diagram of the report viewing component. It is adapted to show an illustrative routine to formulate at least one report based on at least one survey invitation.

### DESCRIPTION OF THE PREFERRED EMBODIMENTS

The present invention generally relates to a survey presentation and processing system. Aspects of the present invention are the embodiment for a real time, online feedback portal to understand the experiences and perceptions of individuals at various stages of the pre-employment to post-employment life cycle.

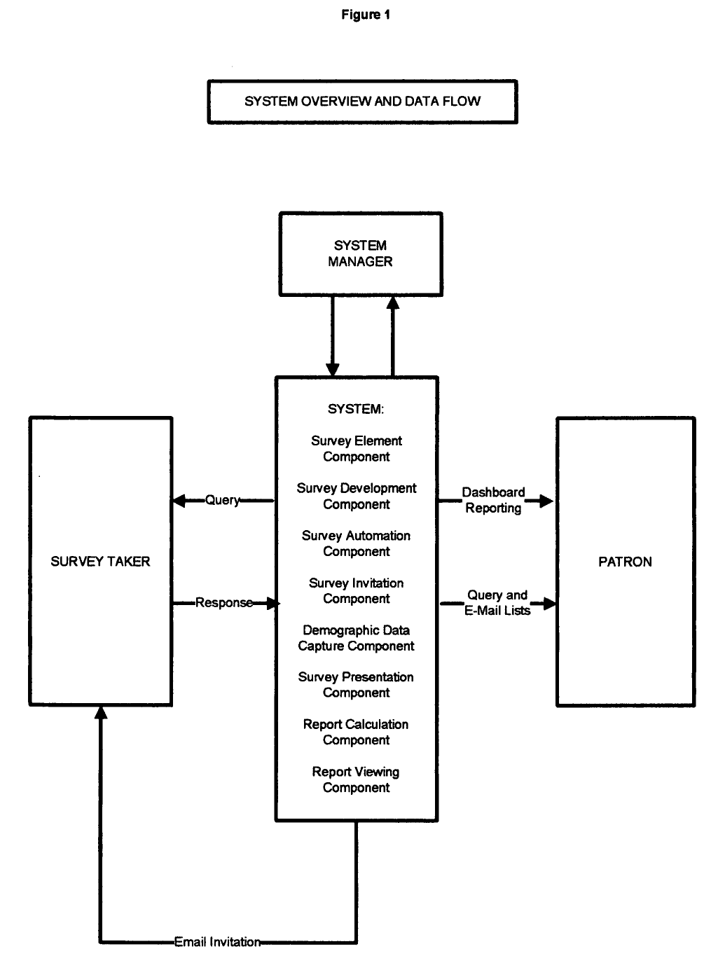

FIG. 1 shows an illustrative system overview, data flow and operating environment of the present invention. It is an internet-based survey system that collects feedback from a company's talent pool of potential employees, recently hired employees, long term employees and/or those separating from employment. An illustrative embodiment of the system includes a survey element component adapted to create survey questions; a survey development component adapted to present and customize a standard library of survey questions; a survey automation component adapted to capture requisite identification information about potential survey takers; a survey invitation component adapted to solicit participation from potential survey takers; a demographic data capture component adapted to solicit demographic background information from survey takers; a survey presentation component adapted to present survey questions in real-time to survey takers; a report calculation component adapted to calculate survey participation, aggregate scoring and benchmark data; and a report presentation component adapted to present results to clients.

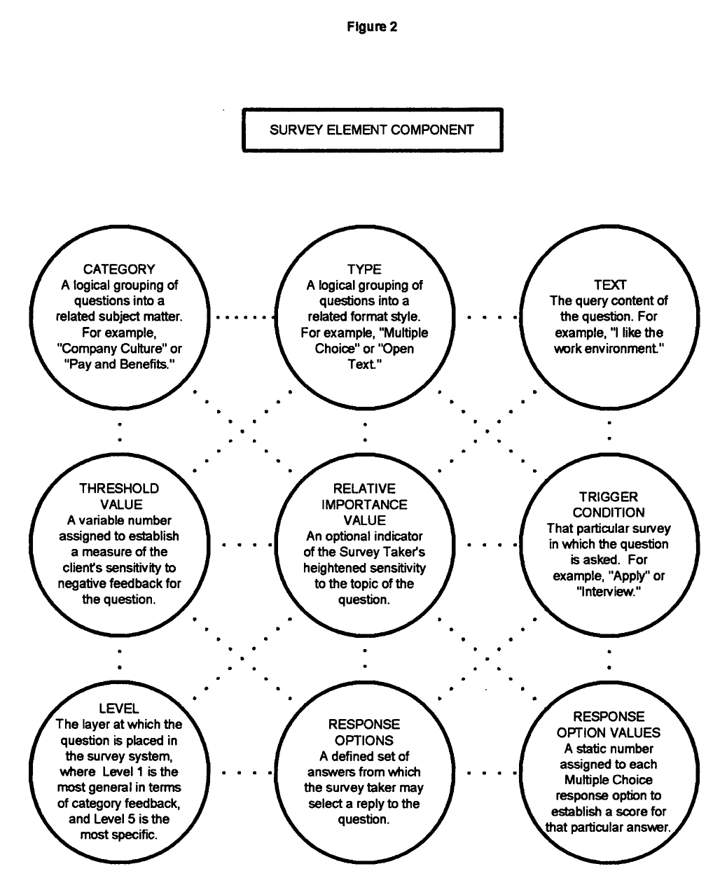

Referring now to FIG. 2, which illustrates the format and subcomponents of the survey questions. Survey questions are central to the invention, and their responses are utilized to generate reports in the survey system. The questions are designed to solicit information regarding the perceptions and experiences of individuals at key points in the employment lifecycle, using online surveys accessed by a secure server. The question elements include the category, which logically groups questions into a related subject matter; the type, which logically groups questions into a related format style; the text, which is the content of the query; the threshold value, which illustrates a variable number assigned to establish a measure of the client's sensitivity to negative feedback for the question; the relative importance value, which illustrates an optional designation of the survey taker's heightened sensitivity to the topic of the question; the trigger condition, which is that particular survey in which the question is posed to the survey taker; the level, which is the layer at which the question is placed in the survey system, where Level 1 is the highest layer and most general in terms of category feedback and Level 5 is the lowest layer and most specific in terms of category feedback; the response options, which are a defined set of answers from which a reply to the question is selected; and the response option values, which illustrate a static number (or score) that is assigned to each response option. The relational nature of these elements, and other aspects and features, are advantages of the present invention.

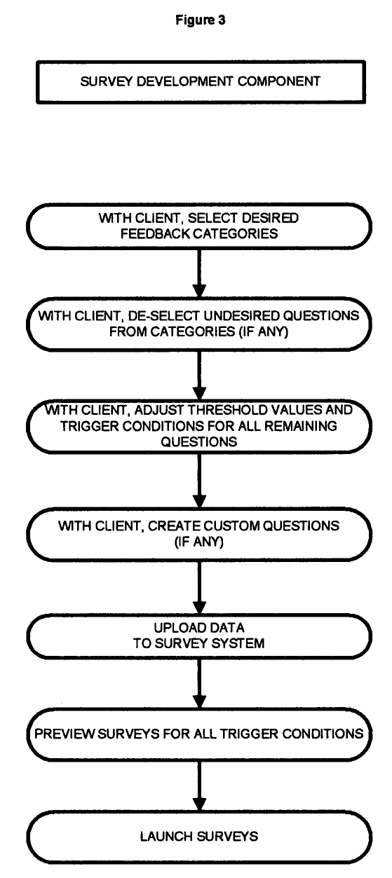

FIG. 3 describes the process of developing a set of electronic surveys from a client's unique order form. It is a survey development component adapted to present and customize a standard library of survey questions for use in the survey system. In this process the client selects desired feedback categories; deselects undesired questions from within those categories; selects the threshold values and trigger conditions for all remaining questions; and creates desired custom questions, if any. The survey is then uploaded to the survey system, previewed for accuracy, and subsequently made available to survey takers who are invited to provide feedback in the system. This system and method help companies to calibrate the relationship between improvements to early workforce engagement, experience and perception with improvements to business performance metrics. These and other aspects and features are advantages of the present invention.

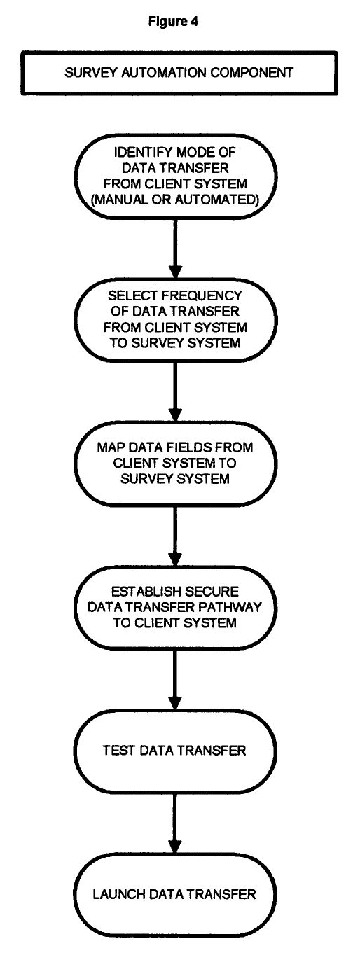

Turning to FIG. 4, in which survey automation is illustrated. This is a flow diagram showing an illustrative routine of data transfer from a client's system to provide requisite identification information about a potential survey taker. The client selects a method and frequency of data transfer; a mapping process is then completed to interpret and correctly match fields of data in the client system to fields of data entry in the survey system; a secure data transfer pathway is established between the two systems; the pathway is tested to confirm successful operation; and the survey automation component is ready for use in the survey system. These and other aspects and features are advantages of the present invention.

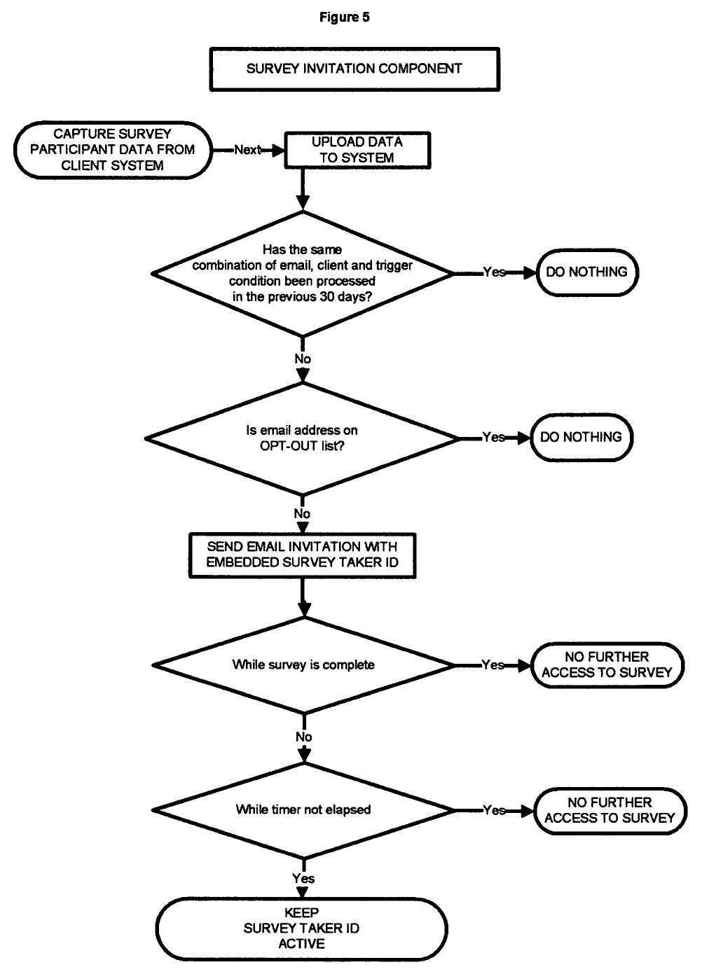

FIG. 5 describes the process of extending electronic invitations to participate in the surveys. It is a flow diagram showing an illustrative routine and embedded logic in which survey taker identification data (including email address and trigger condition) enters the survey system. Logic is applied to determine if the same combination of email address and trigger condition have been received in the system for that particular client in the most recent 30 day period; if the answer is negative then logic is applied to determine if the survey taker has previously requested to opt-out from future contact with the survey system; if the answer is negative then a survey invitation corresponding to the associated trigger condition is sent to the email address. The survey invitation contains a link with an embedded Survey Taker ID (SID) that remains active in the survey system for a defined period of time. The SID remains active until the survey is completed in the survey system, or until the time period elapses. These and other aspects and features are advantages of the present invention.

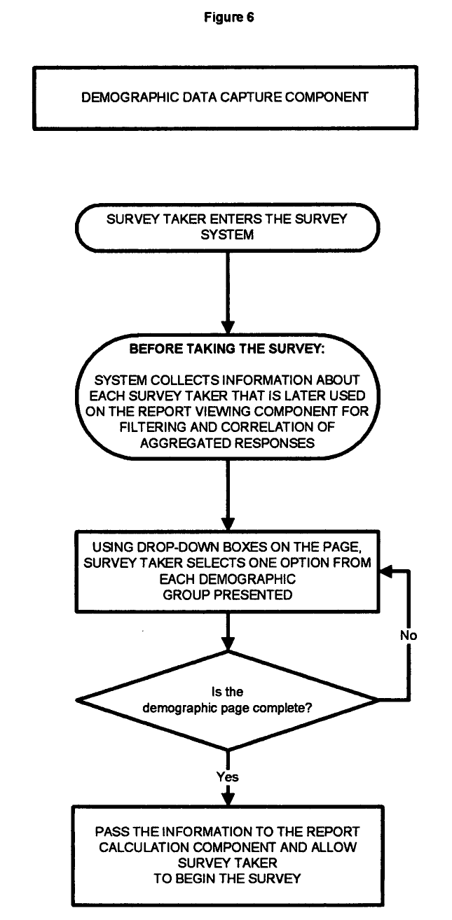

Referring now to FIG. 6, in which demographic data capture is illustrated. This is a flow diagram showing an illustrative routine of capturing demographic background information from at least one survey taker. In this component the system collects demographic factors about survey takers which are later used in the report viewing component for filtering and correlation of aggregate responses. The survey taker enters the survey system and selects one or more options from each demographic group. When all demographic groups are populated with selections, the survey taker may start answering survey questions. These and other aspects and features are advantages of the present invention.

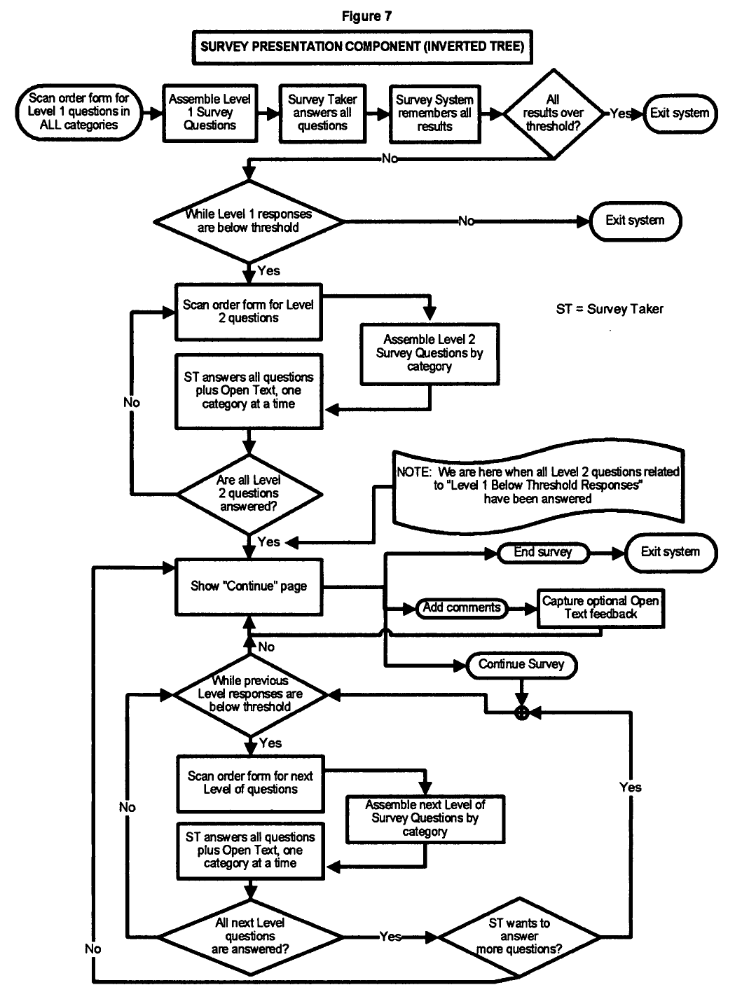

FIG. 7 describes the presentation of a survey to at least one survey taker. It is a flow diagram showing an illustrative routine in which the survey system first scans the client's unique order form to assemble and present Level 1 questions for all selected categories. When responses have been captured and stored for all Level 1 questions, logic is applied to compare these response values to the designated question threshold values; if all response values are above the designated thresholds the survey taker is asked no further questions, but is directed by the system to a page with options to review responses, provide open text comments, or exit the survey system. If any Level 1 response value is below the designated threshold value for that question, the survey system scans the client's order form to assemble and present Level 2 questions associated only with that particular Level 1 category. When responses have been captured and stored for all Level 2 questions, logic is applied to compare these response values to the designated question threshold values; if all response values are above the designated thresholds the survey taker is asked no further questions, but is directed by the system to a review page with options to review responses, provide open text comments, or exit the survey system. If any Level 2 response value is below the designated threshold value for that question, the survey system scans the client's order form to assemble Level 3 questions associated only with that particular Level 2 subcategory; the survey taker is then directed to a review page with options to continue answering questions, provide open text comments, review responses, or exit the survey system. If the survey taker chooses to continue answering questions, the system presents the previously assembled Level 3 questions. When responses have been captured and stored for all Level 3 questions, logic is applied to compare these response values to the designated question threshold values; if all response values are above the designated thresholds the survey taker is asked no further questions, but is directed by the system to a review page with options to review responses, provide open text comments, or exit the survey system. If any Level 3 response value is below the designated threshold value for that question, the survey system scans the client's order form to assemble and present Level 4 questions associated only with that particular Level 3 subcategory. When responses have been captured and stored for all Level 4 questions, the survey system compares the response values to the designated question threshold values; if all response values are above the designated thresholds the survey taker is asked no further questions, but is directed by the system to a review page with options to review responses, provide open text comments, or exit the survey system. If any Level 4 response value is below the designated threshold value for that question, the survey system scans the client's order form to assemble and present Level 5 questions associated only with that particular Level 4 subcategory. When responses have been captured and stored for all Level 5 questions, the survey taker is directed to a review page with options to review responses, provide open text comments, or exit the survey system. These and other aspects and features are advantages of the present invention.

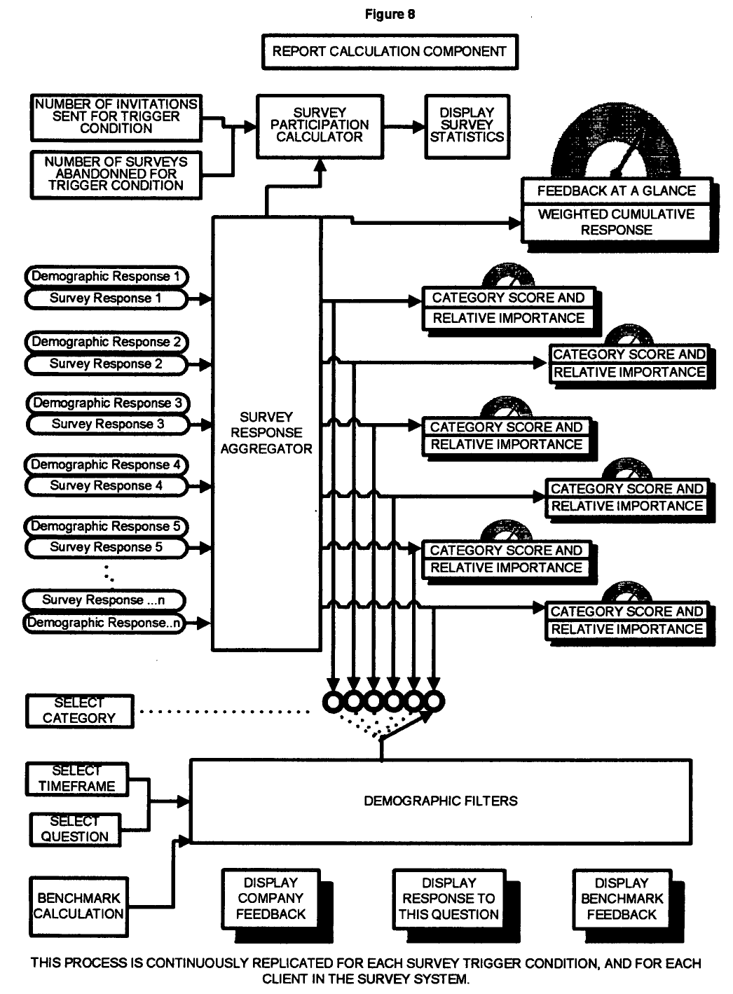

Referring now to FIG. 8, which describes calculations performed in the survey system to prepare the data for client report viewing. In this component the system tracks for each client their real-time survey participation rates by calculating (for each trigger condition) the number of invitations sent, the number of surveys abandoned (e.g., started but not completed), and the number of surveys completed. This component also calculates “Feedback at a Glance,” which is an aggregate score for all of the client's Level 1 responses. This component also calculates an aggregate score for each of the client's selected categories of questions, and the relative importance of each category to survey takers based on responses. This component also calculates scores for each question, and the relative importance of each question to survey takers based on their responses. This component also calculates demographic statistics of survey participants. Finally, this component aggregates each of these calculations for all clients in the survey system for the purpose of providing benchmark data. These and other aspects and features are advantages of the present invention.

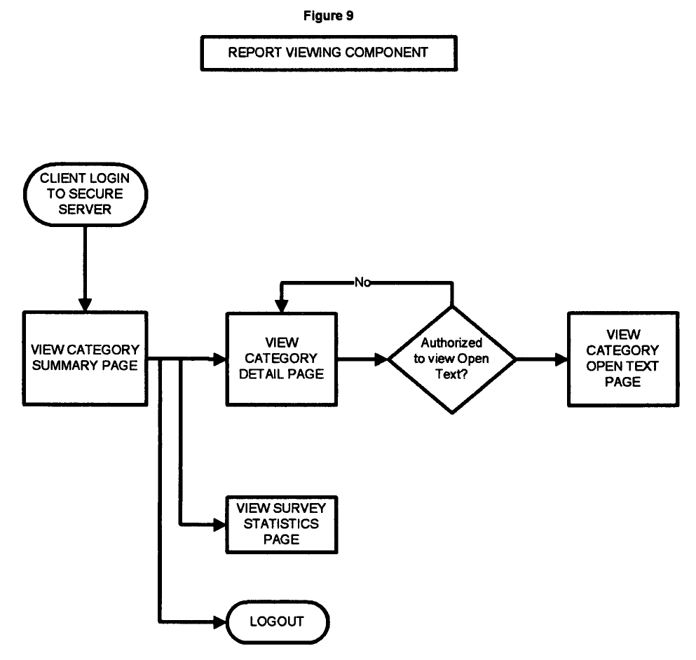

FIG. 9 is an illustrative routine of a report viewing and presentation component adapted to formulate at least one report for at least one client based on survey responses stored in the survey system. It describes the routines for report viewing in which the client logs into the system on a secure server and views the category summary page which contains summary calculations and rankings for each category. From this page the client may choose to view the category detail page, which provides the aggregate response calculations and benchmark data for every question presented to survey takers in that selected category; the client may also choose to view the survey statistics page, which contains collective tabulations for survey participation and abandonment. From the category detail page the client may optionally access the category open text page, which contains free form comments from survey takers relative to each category; system permission is required to access this page due to the potentially sensitive nature of HR-related feedback. The client may print the reports in a variety of formats, and may logout after reviewing the reports. These and other aspects and features are advantages of the present invention.

Based upon the foregoing, the present invention relates to a real-time, online feedback portal that helps companies understand the experiences and perceptions of individuals at all stages of the employment life cycle. It should be appreciated that the present invention provides a method, computer system and computer readable medium. As a conducting diagnostic tool, the system gathers and measures feedback to help companies learn how they are perceived as employers and what changes they can make to enhance that image in order to attract, find, keep, and predict better hires. The system includes a software program that enables clients to solicit information regarding the demographics, perceptions and experiences of individuals at key points in the employment lifecycle, using online surveys accessed by survey takers over a secure server. Using feedback obtained through the aggregate survey results, a company can continually adjust or modify its recruitment, employment and/or retirement policies and programs accordingly, to improve and facilitate the recruitment, employment and retention of talented and productive employees. The above specifications, explanation and data provide complete description, composition and use of this invention. The invention resides in the claims hereinafter appended.

I claim the following:

1. An Internet-based system and method to solicit information regarding the demographics, perceptions and experiences of individuals at key points in the employment lifecycle, using online surveys accessed by survey takers over a secure server; wherein the determining step comprises Survey Element Component adapted to create survey question; Survey Development Component adapted to present and customize a standard library of survey elements for client; Survey Automation Component adapted to capture required identification information about survey taker from client; Survey Invitation Component adapted to solicit participation from survey taker; Demographic Capture Component adapted to solicit demographic background information from survey taker; Survey Presentation Component adapted to present survey elements dynamically in real-time and receive survey response from survey taker; Report Calculation Component adapted to calculate survey participation, survey taker demographics, aggregate response option values and benchmarking based on survey response for at least client; report viewing and Presentation Component Adapted to present report to client.

2. The method and system of claim 1 wherein said survey elements comprise category, type, text, threshold value, relative importance value, trigger condition, level, response options, and response option values.

3. The system of claim 1 wherein said survey elements are saved in a question format and include information specific to that unique question's category, type, text, threshold value, relative importance value, trigger conditions, level, response options and response option values.

4. The system of claim 1 wherein said survey questions are stored in a question library, from which categories and questions may be deselected if the resulting feedback is not desired by the client when creating a unique order form; in which specific threshold values and trigger conditions may be established for all selected questions; and with which custom questions may be created if desired.

5. The system of claim 1 wherein said questions are presented to survey takers dynamically in real-time, resulting in a survey that is interactively created by each survey taker's unique responses and feedback.

6. The system of claim 1 wherein said response data is scored, categorized, aggregated, benchmarked and presented to clients in real-time using a simple, user-friendly interface. From this interface the client views current and historical survey response data, including summarized and detailed calculations, rankings and benchmarking for each category and question within each category. From this interface the client may also view survey participation and abandonment rates for each trigger condition.
